(19) United States
(12) Patent Application Publication
(10) Pub. No.: US 2026/0182650 A1
(43) Pub. Date: Jul. 2, 2026

(54) AEROSOL-GENERATING DEVICE

(71) Applicant: KT&G CORPORATION, Daejeon (KR)

(72) Inventor: Sangkyu PARK, Seoul (KR)

(73) Assignee: KT&G CORPORATION, Daejeon (KR)

(21) Appl. No.: 19/350,886

(22) Filed: Oct. 6, 2025

(30) Foreign Application Priority Data
Dec. 27, 2024 (KR) 10-2024-0198567

(51) Int. Cl. A24F 40/46

(52) U.S. Cl. CPC A24F 40/46

(57) ABSTRACT

Disclosed is an aerosol-generating device. The aerosol-generating device includes an antenna configured to radiate microwaves to an insertion space accommodating an aerosol-generating article, a source unit configured to provide a radio-frequency (RF) signal to the antenna, and a printed circuit board connected to the source unit and the antenna. The printed circuit board includes a first part including a first insulating layer and a transmission line disposed on one surface of the first insulating layer and electrically connected to the source unit and the antenna, and a characteristic impedance of the first part corresponds to an input impedance of the antenna.

### CROSS-REFERENCE TO RELATED APPLICATIONS

Pursuant to 35 U.S.C. § 119 (a), this application claims the benefit of earlier filing date and right of priority to Korean Patent Application No. 10-2024-0198567 filed on Dec. 27, 2024, the contents of which are all hereby incorporated by reference herein in their entireties.

### BACKGROUND OF THE DISCLOSURE

### 1. Field of the Disclosure

The present disclosure relates to an aerosol-generating device.

### 2. Description of the Related Art

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various studies on aerosol-generating devices have been conducted.

In an aerosol-generating device employing a dielectric heating method, a radio-frequency (RF) signal generated by a source unit is transmitted to an antenna, and the antenna radiates microwaves to an insertion space, thereby heating an aerosol-generating substance in an aerosol-generating article.

In the conventional aerosol-generating device employing a dielectric heating method, the source unit and the antenna are connected using a wire or a coaxial cable. When a wire is used, impedance matching between the antenna and the wire may not be achieved, which may result in failure to efficiently transmit an RF signal to the antenna or in damage to the source unit caused by a reflected signal. On the other hand, when a coaxial cable is used, miniaturization of the device is not possible due to the size and volume of the coaxial cable.

### SUMMARY OF THE DISCLOSURE

It is an object of the present disclosure to solve the above and other problems.

It is another object of the present disclosure to provide an aerosol-generating device in which a printed circuit board includes a part that connects a source unit to an antenna and that has a characteristic impedance corresponding to an input impedance of the antenna.

It is still another object of the present disclosure to provide an aerosol-generating device in which a transmission line and an insulating layer of the printed circuit board have thicknesses and widths within a predetermined range.

It is still another object of the present disclosure to provide an aerosol-generating device in which the printed circuit board includes a part that connects a coupler to a processor as well as the part that connects the source unit to the antenna.

In accordance with an aspect of the present disclosure for accomplishing the above and other objects, there is provided an aerosol-generating device including an antenna configured to radiate microwaves to an insertion space accommodating an aerosol-generating article, a source unit configured to provide a radio-frequency (RF) signal to the antenna, and a printed circuit board connected to the source unit and the antenna, wherein the printed circuit board includes a first part including a first insulating layer and a transmission line disposed on one surface of the first insulating layer and electrically connected to the source unit and the antenna, and a characteristic impedance of the first part corresponds to an input impedance of the antenna.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF THE DRAWINGS

The above and other objects, features, and other advantages of the present disclosure will be more clearly understood from the following detailed description taken in conjunction with the accompanying drawings, in which:

FIG. 1 is a block diagram of an aerosol-generating device according to an embodiment of the present disclosure;

FIG. 2 is a view showing an aerosol-generating device according to an embodiment of the present disclosure;

FIGS. 3 and 4 are views showing an antenna according to an embodiment of the present disclosure;

FIG. 5 is a perspective view of a first part according to an embodiment of the present disclosure;

FIG. 6 is a cross-sectional view of the first part according to the embodiment of the present disclosure;

FIG. 7 is a perspective view of a second part according to an embodiment of the present disclosure;

FIG. 8 is a cross-sectional view of the second part according to the embodiment of the present disclosure;

FIG. 9 is a perspective view of a printed circuit board including the first part and the second part according to an embodiment of the present disclosure;

FIG. 10 is a cross-sectional view of the printed circuit board including the first part and the second part according to the embodiment of the present disclosure;

FIG. 11 is a perspective view of a printed circuit board including the first part and the second part according to an embodiment of the present disclosure; and

FIG. 12 is a cross-sectional view of the printed circuit board including the first part and the second part according to the embodiment of the present disclosure.

### DETAILED DESCRIPTION OF THE PREFERRED EMBODIMENTS

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. With regard to the description of the drawings, similar reference numerals may be used to refer to similar or related elements.

In the following description, with respect to constituent elements used in the following description, the suffixes “module” and “unit” are used only in consideration of facilitation of description, and do not have mutually distinguished meanings or functions. As used herein, the suffix “module” or “unit” may include a unit implemented in hardware, software, or firmware, and may be used interchangeably with other terms, for example, “logic,” “logic block,” “part,” or “circuitry.” A “module” or a “unit” may be a single integral component, or a minimum unit or part thereof, adapted to perform one or more functions. For example, the “module” or the “unit” may be implemented in the form of an application-specific integrated circuit (ASIC).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and spirit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Embodiments as set forth herein may be implemented as software including one or more instructions that are stored in a storage medium (e.g., a memory 17) that is readable by a machine (e.g., the aerosol-generating device 1). For example, a processor (e.g., the controller 12) of the machine (e.g., the aerosol-generating device 1) may invoke at least one of the one or more instructions stored in the storage medium, and may execute the same. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

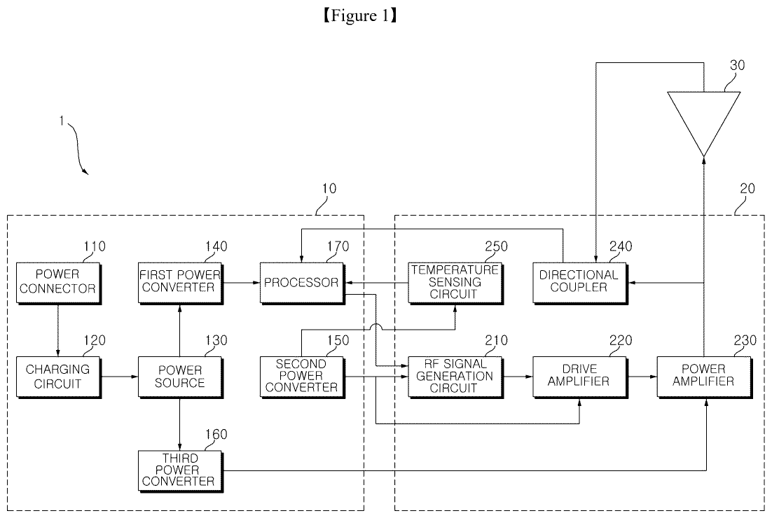

FIG. 1 is a block diagram of an aerosol-generating device 1 according to an embodiment.

In accordance with an embodiment, the aerosol-generating device 1 may include a controller 10, a source unit 20, and a radiating unit 30. The controller 10 may mean a circuit for controlling the basic operation of the aerosol-generating device 1. The source unit 20 may mean a circuit for generating a radio frequency (RF) signal under control of the controller 10. The radiating unit 30 may be an apparatus for radiating the RF signal generated by the source unit 20 to a space into which an aerosol-generating article is inserted (hereinafter, an insertion space) in the form of electromagnetic waves. The radiated electromagnetic waves (e.g., RF signal) may cause charges or ions of a dielectric (e.g., glycerin) contained in the aerosol-generating article to vibrate or rotate, and the aerosol-generating article may be heated as the dielectric is heated by frictional heat generated in the process of the charges or ions vibrating or rotating. In other words, the aerosol-generating device 1 may be an apparatus for generating an aerosol by heating the aerosol-generating article using a dielectric heating method.

In an example, the controller 10 may include a power connector 110, a charging circuit 120, a power source 130, a first power converter 140, a second power converter 150, a third power converter 160, and/or a processor 170. In addition, the source unit 20 may include an RF signal generation circuit 210, a drive amplifier 220, a power amplifier 230, a directional coupler 240, and/or a temperature sensing circuit 250. However, it will be understood by a person having ordinary skill in the art related to the present disclosure that, depending on the design of the aerosol-generating device 1, some of the components shown in FIG. 1 may be omitted or new components may be added.

The power connector 110 may mean a physical connection device that is electrically connected to an electronic device or system external to the aerosol-generating device 1 (e.g., an external power source) and used to transmit and receive power. For example, the power connector 110 may receive power from the external power source, and may transmit the received power to a component that needs to be charged (e.g., the power source 130). The power connector 110 may provide a path for data transmission. The aerosol-generating device 1 may transmit and receive data to and from the external electronic device or system (e.g., smartphone or computer) via the power connector 110. The power connector 110 may include a universal serial bus (USB) power connector and a direct current (DC) power connector. In an example, the power connector 110 may be a USB-C type connector capable of supplying a direct current voltage (DC) of 9 volts (V) at a current of 1 ampere (A), but the present disclosure is not necessarily limited thereto. The power connector 110 may include an interface for wirelessly transmitting and receiving power.

The charging circuit 120 may mean a circuit for charging the power source 130. The charging circuit 120 may charge the power source 130 using power transmitted from the power connector 110. In an example, the charging circuit 120 may be implemented as a charger IC, which is an integrated circuit (IC) that functions to efficiently and safely charge the power source 130. By monitoring the voltage, current, and/or temperature of the power source 130, the charging circuit 120 may monitor the charging state of the power source 130 or optimize the charging process. For example, the charging circuit 120 may detect the state of the power source 130 and provide appropriate charging voltage and current to prevent overcharging or over-discharging.

The power source 130 may supply power for operation of the aerosol-generating device 1. The power source 130 may include one or more rechargeable batteries. The power source 130 may supply power to the radiating unit 30 such that the radiating unit 30 can radiate electromagnetic waves (e.g., RF signal) to the insertion space to heat the aerosol-generating article. Here, the supply of power to the radiating unit 30 may be synonymous with the supply of power to the source unit 20. In addition, the power source 130 may supply power for operation of the processor 170, the RF signal generation circuit 210, the drive amplifier 220, the power amplifier 230, and the temperature sensing circuit 250. In an example, the power source 130 may be, but is not limited to, a lithium polymer (LiPoly) battery. The power source 130 may also be a replaceable (removable) battery (hereinafter, a removable battery). The removable battery may be mounted in a battery compartment provided in the aerosol-generating device 1, or may be removed from the battery compartment. The removable battery may be wired and/or wirelessly charged.

The aerosol-generating device 1 may include a power conversion circuit for converting power supplied from the power source 130 into power (e.g., voltage and/or current) suitable for other components. The power conversion circuit may include at least one of a buck-converter, a buck-boost converter, a boost converter, a Zener diode, and a low-dropout (LDO) regulator. In addition, the power conversion circuit may include a DC/AC converter (e.g., an inverter) as needed.

In an example, the aerosol-generating device 1 may include a first power converter 140, a second power converter 150, and a third power converter 160. The first power converter 140 may be an LDO regulator for supplying suitable power (e.g., DC 3.3 V) to the processor 170, the second power converter 150 may be a buck-boost converter for supplying suitable power (e.g., DC 5 V) to the temperature sensing circuit 250, the RF signal generation circuit 210, and the drive amplifier 220, and the third power converter 160 may be a boost converter for supplying suitable power (e.g., DC 12 V/25 W) to the power amplifier 230.

However, the first power converter 140, the second power converter 150, and the third power converter 160 are not limited to the foregoing examples, and may include other types of power conversion circuits. In addition, although FIG. 1 shows that the aerosol-generating device 1 includes three power converters, the aerosol-generating device 1 may include more than three power converters or less than three power converters. In an example, at least some of the first power converter 140, the second power converter 150, and the third power converter 160 may be integrated into a single power converter.

The processor 170 may control the overall operation of the aerosol-generating device 1. For example, the processor 170 may directly or indirectly control charging and discharging of the power source 130 using the charging circuit 120. In addition, the processor 170 may regulate the voltage and/or current output by the power conversion circuit by regulating the frequency and/or duty ratio of a current pulse input to at least one switching element of the power conversion circuit. The processor 170 may generally control the operation of other components, a description of which will follow, in addition to the components described above.

The processor 170 may be implemented as an array of multiple logic gates or as a combination of a general purpose micro controller unit (MCU) (or, microprocessor) and a memory storing programs that may be executed by the MCU. In addition, it will be understood by a person having ordinary skill in the art to which this embodiment pertains that the processor 170 can be implemented in other forms of hardware.

The RF signal generation circuit 210 may generate an RF signal based on power transmitted from the power source 130 or the second power converter 150. The RF signal may mean a signal having a frequency within a range of 300 MHz to 300 GHz. In an example, the RF signal may have a frequency of 1 GHz to 100 GHz. In addition, the RF signal may have a frequency within an Industrial Scientific and Medical equipment (ISM) band, such as a frequency of 915 MHz, 2.45 GHZ, and/or 5.8 GHz.

The RF signal generation circuit 210 may include a voltage controlled oscillator (VCO) for generating RF signals having different frequencies depending on input voltage. The RF signal generation circuit 210 may receive a control signal (e.g., a DC signal) from the processor 170 and generate an RF signal having a frequency corresponding to the received control signal. The processor 170 may store control signals corresponding to desired frequencies in the form of a look-up table, or may calculate a control signal corresponding to a desired frequency in real time through at least one operation.

In an example, the aerosol-generating device 1 may further include a digital to analog (D/A) converter for converting a digital control signal output from the processor 170 into an analog control signal. The RF signal generation circuit 210 may receive an analog control signal and generate an RF signal having a frequency corresponding to the received analog control signal.

The drive amplifier 220 may amplify the RF signal generated by the RF signal generation circuit 210. For example, the drive amplifier 220 may amplify a signal level (e.g., amplitude) of the RF signal to provide a suitable input signal to the component in the next step (e.g., the power amplifier 230). The drive amplifier 220 may minimize distortion of the signal by maintaining high linearity. However, since the drive amplifier 220 is an amplifier focused on increasing the signal level, the drive amplifier may provide relatively low output power.

The power amplifier 230 may amplify power of the RF signal received from the drive amplifier 220. The power amplifier 230 may be an amplifier focused on providing sufficient power to an end output device (e.g., the radiating unit 30). For example, the power amplifier 230 may provide an RF signal with high power to the radiating unit 30 such that the radiating unit 30 can radiate electromagnetic waves to the insertion space to heat the aerosol-generating article. The power amplifier 230 may perform an amplification operation using power received through the third power converter 160 that provides higher power and/or voltage than the second power converter 150.

Each of the drive amplifier 220 and the power amplifier 230 may include a transistor, such as a bipolar junction transistor (BJT) or a field effect transistor (FET), or a vacuum tube. In an example, each of the drive amplifier 220 and power amplifier 230 may be, but is not necessarily limited to, a gallium nitride (GaN) transistor capable of handling high efficiency, high speed, and high voltage. Each of the drive amplifier 220 and power amplifier 230 may include an operational amplifier.

Although the drive amplifier 220 and the power amplifier 230 are shown as separate amplifiers in FIG. 1, the drive amplifier 220 and the power amplifier 230 may be integrated into a single amplifier. In addition, the drive amplifier 220 and/or the power amplifier 230 may include a plurality of amplifiers connected in series, in parallel, and/or in series and parallel.

The radiating unit 30 may include at least one antenna for radiating electromagnetic waves to the space. The at least one antenna may have a size and shape suitable for the size and shape of the aerosol-generating article. For example, if the aerosol-generating article is cylindrical, the at least one antenna may be formed in a tubular shape surrounding the cylindrical aerosol-generating article. Here, the shape of the antenna being tubular may mean that the overall shape of the antenna is tubular. In other words, if the antenna is made of a metal (e.g., SUS) track, this may mean that the overall shape of the track is tubular. The shape of the at least one antenna is not limited to the foregoing examples and may include a variety of shapes, such as a flat plate shape and a curved plate shape.

The radiating unit 30 may radiate electromagnetic waves (e.g., an amplified RF signal or a transmitted RF signal) to the insertion space to heat the aerosol-generating article. In order for the heating efficiency of the aerosol-generating article to be maximized, resonance of the electromagnetic waves must occur in the insertion space. The resonance condition (e.g., resonance frequency) of the insertion space may vary depending on the amount of dielectric contained in the inserted aerosol-generating article. By adjusting a control signal input to the RF signal generation circuit 210, the processor 170 may control the frequency of the RF signal generated by the RF signal generation circuit 210 so as to correspond to or approach the resonance condition of the insertion space. The processor 170 may use the directional coupler 240 to obtain information about the resonance condition of the insertion space.

The directional coupler 240 may mean a passive element having a waveguide structure capable of separating incident and reflected waves. The directional coupler 240 may receive an RF signal transmitted from the power amplifier 230 toward the radiating unit 30 and electromagnetic waves reflected from the insertion space after being radiated by the radiating unit 30. The directional combiner 240 may separate the transmitted RF signal and the reflected electromagnetic waves and transmit the same to the processor 170.

In an example, the aerosol-generating device 1 may further include an analog to digital (A/D) converter for converting an analog output of the directional coupler 240 into a digital output. The A/D converter may be embedded in the processor 170, or may be provided as a separate component external to the processor 170. By monitoring the output of the directional coupler 240, the processor 170 may analyze characteristics (e.g., current, voltage, power, phase, and/or frequency) of the transmitted RF signal and characteristics (e.g., current, voltage, power, phase, and/or frequency) of the reflected electromagnetic waves.

Based on the characteristics of the transmitted RF signal, the processor 170 may determine whether the operation of the source unit 20 is being performed as intended. In addition, the characteristics of the transmitted RF signal may be used in conjunction with the characteristics of the reflected electromagnetic waves to determine the heating efficiency of the source unit 20 or the radiating unit 30. The processor 170 may control the source unit 20 such that the heating efficiency of the source unit 20 or the radiating unit 30 is maximized. For example, the processor 170 may adjust the frequency of the RF signal generated by the RF signal generation circuit 210 such that the power of the reflected electromagnetic waves is minimized. Minimizing the power of the reflected electromagnetic waves may mean that the frequency of the RF signal approaches the resonance condition of the insertion space. The characteristics of the transmitted RF signal may provide a criterion for whether the power of the reflected electromagnetic waves is minimized.

Since resonance of the electromagnetic waves in the insertion space may occur depending on the frequency of the RF signal, the insertion space may be referred to as a resonance unit. At least a part of the insertion space may be surrounded by at least one shielding member to prevent electromagnetic waves from leaking out of the aerosol-generating device 1. In accordance with an embodiment, the insertion space may further include a physical structure for ensuring that resonance occurs within a range controllable by the processor 170. The physical structure may include at least one conductor, and the resonance condition of the insertion space may vary depending on the placement, thickness, and length of the conductor. In addition, the physical structure may include a space for receiving a dielectric with low electromagnetic wave absorbance, independent of the dielectric contained in the aerosol-generating article. The dielectric with low electromagnetic wave absorbance may change the resonant frequency of the entirety of the resonance unit without absorbing energy that must be transmitted to an object to be heated. Accordingly, the resonance condition may be determined to be within a range controllable by the processor 170 even as the resonance unit is miniaturized.

The temperature sensing circuit 250 may be disposed in contact with or adjacent to the components included in the source unit 20 to measure the temperature of the source unit 20. For example, the temperature sensing circuit 250 may be disposed in contact with or adjacent to at least one of the RF signal generation circuit 210, the drive amplifier 220, and the power amplifier 230. In the process of generating and/or amplifying the RF signal, heat may be generated due to limited efficiency, and if excessive, the heat may adversely affect the components included in the source unit 20 or the other components included in the aerosol-generating device 1. The temperature measured by the temperature sensing circuit 250 may be used to prevent the source unit 20 from overheating.

The processor 170 may receive the measured temperature (or a value corresponding to the temperature) from the temperature sensing circuit 250 and may interrupt the operation of the source unit 20 upon determining that the source unit 20 is overheating. For example, the processor 170 may interrupt the operation of the source unit 20 by interrupting the supply of power to the source unit 20 or by sending a control signal. Hereinafter, the term “the supply of power to the source unit 20” will be used to mean controlling whether the source unit 20 operates.

The temperature sensing circuit 250 may include at least one of a thermocouple, a resistance temperature detector (RTD), a thermistor, a semiconductor temperature sensor, and an optical temperature sensor. In an example, the temperature sensing circuit 250 may be implemented as a chip-type sensor (e.g., a negative temperature coefficient (NTC) sensor) to minimize the area occupied thereby, but the present disclosure is not necessarily limited thereto.

Meanwhile, the aerosol-generating device 1 may further include other components in addition to the components shown in FIG. 1. For example, the aerosol-generating device 1 may further include a sensor unit, an output unit, an input unit, a communication unit, and a memory. Also, if the aerosol-generating device 1 is a hybrid type device that uses both an aerosol-generating article and a cartridge, the aerosol-generating device 1 may further include a cartridge heater. The cartridge heater may receive power from the power source 130 to heat a medium and/or aerosol-generating substance in the cartridge.

In accordance with an embodiment, the sensor unit may sense the state of the aerosol-generating device 1 or the state in the vicinity of the aerosol-generating device 1 and transmit sensed information to the processor 170. For example, the sensor unit may include a temperature sensor, a puff sensor, an insertion detection sensor, a reuse detection sensor, an overmoisture detection sensor, a cigarette identification sensor, a cartridge detection sensor, a cap detection sensor, and/or a motion detection sensor. Meanwhile, the sensor unit may further include various sensors, such as a liquid level sensor for detecting a liquid level in the cartridge and a flood sensor for detecting flooding of the aerosol-generating device 1.

In accordance with an embodiment, the temperature sensor may detect the temperature of the insertion space or the aerosol-generating article. The temperature sensor may be disposed in contact with or adjacent to the insertion space or the aerosol-generating article to directly measure the temperature of the insertion space or the aerosol-generating article. Alternatively, the temperature sensor may be disposed spaced apart from the insertion space or the aerosol-generating article to indirectly (e.g., contactlessly) measure the temperature of the insertion space or the aerosol-generating article. In an example, the temperature sensor may include an optical temperature sensor (e.g., an infrared temperature sensor).

In accordance with an embodiment, the temperature sensor may sense the temperature of the power source 130. The temperature sensor may be disposed adjacent to the power source 130. For example, the temperature sensor may be attached to one surface of the power source 130 (e.g., a battery), and/or mounted on one surface of a printed circuit board. In an example, the aerosol-generating device 1 may include a protection circuit module (PCM), and the temperature sensor may be disposed adjacent to the power source 130 along with the protection circuit module.

In accordance with an embodiment, the temperature sensor may be disposed in a housing (not shown) of the aerosol-generating device 1 to sense the temperature in the housing (not shown).

In accordance with an embodiment, the puff sensor may detect a user's puff.

In an example, the puff sensor may include a pressure sensor. The pressure sensor may output a signal corresponding to the internal pressure of the aerosol-generating device 1, and the processor 170 may detect the user's puff based on the signal corresponding to the internal pressure. Here, the internal pressure of the aerosol-generating device 1 may correspond to the pressure of an airflow path in which gas flows. The puff sensor may be disposed in the aerosol-generating device 1 so as to correspond to the airflow path in which the gas flows.

In another example, the puff sensor may include a temperature sensor. When a user puffs, a temporary temperature drop may occur in the airflow path, the insertion space, and the aerosol-generating article. The processor 170 may detect the user's puff based on a signal corresponding to the temperature of the airflow path output from the temperature sensor.

In another example, the puff sensor may include both a pressure sensor and a temperature sensor. In this case, the temperature sensor may measure a temperature that is used to calibrate the internal pressure measured by the pressure sensor. In an example, the puff sensor may calibrate a signal corresponding to the internal pressure based on the temperature measured by the temperature sensor and output the calibrated signal. In another example, the puff sensor may output a signal corresponding to the temperature measured by the temperature sensor and a signal corresponding to the internal pressure measured by the puff sensor. In this case, the processor 170 may receive the signals and calibrate the signal corresponding to the internal pressure based on the signal corresponding to the temperature.

In another example, the puff sensor may include a capacitive sensor. In the present disclosure, the capacitive sensor may also be referred to as a cap sensor or a capacitance sensor. When the user puffs, a temperature change and/or the flow of the aerosol in the insertion space may occur, whereby the dielectric constant in the insertion space may change. The processor 170 may detect the user's puff based on a signal corresponding to the dielectric constant of the insertion space output from the capacitive sensor.

The puff sensor is not limited to the examples described above and may be implemented as a variety of sensors for detecting the user's puff.

In accordance with an embodiment, the insertion detection sensor may detect insertion and/or removal of the aerosol-generating article. The insertion detection sensors may be installed in the vicinity of the insertion space.

In an example, the insertion detection sensor may include a capacitive sensor. The capacitive sensor may include at least one conductor, wherein the at least one conductor may be disposed adjacent to the insertion space. When the aerosol-generating article is inserted into or removed from the insertion space, the dielectric constant around the conductor may change. The processor 170 may detect the insertion and/or removal of the aerosol-generating article based on a signal corresponding to the dielectric constant in the insertion space output from the capacitive sensor.

In another example, the insertion detection sensor may include an inductive sensor. The inductive sensor may include at least one coil, wherein the at least one coil may be disposed adjacent to the insertion space. If the aerosol-generating article (e.g., a wrapper of the aerosol-generating article) includes a conductor, insertion or removal of the aerosol-generating article into or from the insertion space may cause a change in magnetic field around the coil in which the current flows. The processor 170 may detect the insertion and/or removal of the aerosol-generating article including the conductor based on the characteristics of the current output from or sensed by the inductive sensor (e.g., the frequency of the alternating current, current value, voltage value, inductance value, and impedance value). Alternatively, the aerosol-generating article (e.g., a medium unit of the aerosol-generating article) may include a susceptor (SUS). Even in this case, a change in magnetic field may occur around the coil based on the insertion or removal of the susceptor into or from the insertion space, and the processor 170 may detect the insertion and/or removal of the aerosol-generating article based on the characteristics of the current in the inductive sensor.

The insertion detection sensor is not limited to the examples described above and may be implemented as a variety of sensors (e.g., a proximity sensor) for detecting insertion and/or removal of the aerosol-generating article. In addition, the insertion detection sensor may include any combination of the above examples. In accordance with an embodiment, the insertion detection sensor may include a switch for detecting pressing by the aerosol-generating article.

In accordance with an embodiment, the reuse detection sensor may detect whether the aerosol-generating article is reused. In an example, the reuse detection sensor may be a color sensor for detecting the color of the aerosol-generating article. When the aerosol-generating article is used by the user, the generated aerosol or heating may cause a change in color of a part of the wrapper surrounding the outside of the aerosol-generating article. The color sensor may output a signal corresponding to optical characteristics (e.g., the wavelength of light) corresponding to the color of the wrapper based on light reflected from the wrapper. The processor 170 may determine that the aerosol-generating article inserted into the insertion space has already been used if a change in color of a part of the wrapper is detected.

In accordance with an embodiment, the overmoisture detection sensor may detect whether the aerosol-generating article is overmoisturized. For example, the overmoisture detection sensor may include a capacitive sensor. The capacitive sensor may include at least one conductor disposed adjacent to the insertion space. The processor 170 may detect whether the aerosol-generating article is overmoisturized based on the level of a signal corresponding to the dielectric constant output from the capacitive sensor. In an example, the processor 170 may determine a level range within which the level of the signal is included based on the look-up table, and determine the amount of moisture in the aerosol-generating article based on the determined level range.

In accordance with an embodiment, the cigarette identification sensor may detect whether the aerosol-generating article is authentic, and/or detect the type of aerosol-generating article.

In an example, the cigarette identification sensor may include an optical sensor for detecting an identification substance (or an identification mark) located on an outer surface (e.g., the wrapper) of the aerosol-generating article. The optical sensor may radiate light toward the identification substance (or the identification mark) on the aerosol-generating article and detect the authenticity and/or type of the aerosol-generating article based on the reflected light. For example, the identification substance may include a substance that emits light having a specific wavelength band based on the radiated light. Based on the wavelength band, the processor 170 may detect the authenticity and/or type of the aerosol-generating article.

In another example, the cigarette identification sensor may include a capacitive sensor. Depending on the type of aerosol-generating article inserted into the insertion space, the dielectric constant in the insertion space may vary. The processor 170 may detect the authenticity and/or type of the aerosol-generating article based on a signal corresponding to the dielectric constant in the insertion space output from the capacitive sensor.

In another example, the cigarette identification sensor may include an inductive sensor. If the wrapper and/or the inside (e.g., the medium unit) of the aerosol-generating article inserted into the insertion space includes a conductor, the characteristics of the current sensed by the inductive sensor (e.g., the frequency of alternating current, current value, voltage value, inductance value, and impedance value) may vary when the aerosol-generating article is inserted into the insertion space depending on the type of aerosol-generating article inserted into the insertion space. Based on the characteristics of the current output from the inductive sensor or sensed by the inductive sensor, the processor 170 may detect the authenticity and/or type of the inserted aerosol-generating article.

The cigarette identification sensor is not limited to the examples described above and may be implemented as a variety of sensors for sensing the authenticity of the aerosol-generating article and/or sensing the type of aerosol-generating article. In addition, the cigarette identification sensor may include any combination of the above examples.

In accordance with an embodiment, the cartridge detection sensor may detect the insertion and/or removal of the cartridge. For example, the cartridge detection sensor may include an inductive sensor, a capacitive sensor, a resistance sensor, a Hall sensor (a Hall IC), and/or an optical sensor.

In accordance with an embodiment, the cap detection sensor can detect mounting and/or removal of a cap. For example, the cap detection sensor may include an inductive sensor, a capacitive sensor, a resistance sensor, a contact sensor, a Hall sensor (a Hall IC), and/or an optical sensor. The cap may include a structure that covers at least a part of the cartridge mounted or inserted into the aerosol-generating device 1 or that covers at least a part of the housing of the aerosol-generating device 1. The cap detection sensor may output a signal corresponding to mounting or removal when the cap is mounted to or removed from the housing, and the processor 170 may detect mounting or removal of the cap based on a signal corresponding to mounting or removal.

In accordance with an embodiment, the motion detection sensor may detect the motion of the aerosol-generating device 1. The motion detection sensor may be implemented as at least one of an acceleration sensor or a gyro sensor.

In accordance with an embodiment, the sensor unit may further include at least one of a humidity sensor, a barometric pressure sensor, a magnetic sensor, a position sensor (a global positioning system (GPS) sensor), or a proximity sensor in addition to the aforementioned sensors. The function of each sensor may be intuitively deduced by those skilled in the art from the designation thereof, and thus a detailed description thereof will be omitted.

In accordance with an embodiment, the output unit may output information about the state of the aerosol-generating device 1. The output unit may include, but is not limited to, a display, a haptic portion, and/or an acoustic output portion. For example, information about the aerosol-generating device 1 may include the charging/discharging state of the power source 130 of the aerosol-generating device 1, the operational state of the source unit 20 or the radiating unit 30, the insertion/removal state of the aerosol-generating article and/or the cartridge, the mounting and/or removal state of the cap, or the state in which the use of the aerosol-generating device 1 is restricted (e.g., detection of an abnormal article). The display may visually provide information about the state of the aerosol-generating device 1 to the user. For example, the display may include a light emitting diode (LED), a liquid crystal display (LCD), or an organic light emitting diode (OLED). The display may be used as an input unit if the display includes a touch pad. The haptic portion may tactually provide information about the state of the aerosol-generating device 1 to the user. For example, the haptic portion may include a vibration motor, a piezoelectric element, or an electrical stimulation device. The acoustic output portion may audibly provide information about the aerosol-generating device 1 to the user. For example, the acoustic output portion may convert an electrical signal into an acoustic signal and output the same to the outside.

In accordance with an embodiment, the input unit may receive information input by the user. For example, the input unit may include a touch panel, a button, a keypad, a dome switch, a jog wheel, or a jog switch.

In accordance with an embodiment, the memory is hardware for storing various data processed in the aerosol-generating device 1, and may store data processed and to be processed by the processor 170. For example, the memory may include at least one of a flash memory type memory, a hard disk type memory, a multimedia card micro type memory, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disc. For example, the memory may store data about the operating time of the aerosol-generating device 1, the maximum number of puffs, the current number of puffs, at least one temperature profile, and a user's smoking pattern.

In accordance with an embodiment, the communication unit may include at least one component for communication with other electronic devices (e.g., a portable electronic device). For example, the communication unit may include a Bluetooth communication unit, a Bluetooth low energy (BLE) communication unit, a near field communication unit, a wireless local area network (WLAN) communication unit, a ZigBee communication unit, an infrared data association (IrDA) communication unit, a Wi-Fi Direct (WFD) communication unit, an ultra-wideband (UWB) communication unit, an adaptive network topology (ANT)+communication unit, a cellular network communication unit, an Internet communication unit, or a computer network (e.g., LAN or WAN) communication unit.

In accordance with an embodiment, the processor 170 may control the temperature of the insertion space or the aerosol-generating article by controlling the amplification rate of the source unit 20 (e.g., the power amplifier 230). The processor 170 may control the amplification rate of the source unit 20 (e.g., the power amplifier 230) based on the temperature of the insertion space or the aerosol-generating article sensed using the temperature sensor. The processor 170 may control the amplification rate of the source unit 20 (e.g., the power amplifier 230) based on a temperature profile and/or a power profile stored in the memory.

In addition, the processor 170 may control the temperature of the cartridge heater by controlling the supply of power from the power source 130 to the cartridge heater. The processor 170 may control the temperature of the cartridge heater and/or the power supplied to the cartridge heater based on the temperature of the cartridge heater sensed using the temperature sensor. The processor 170 may control the temperature of the cartridge heater and/or the power supplied to the cartridge heater based on the temperature profile and/or the power profile stored in the memory.

In accordance with an embodiment, the processor 170 may prevent the insertion space, the aerosol-generating article, and/or the cartridge heater from overheating. For example, the processor 170 may control the operation of the power conversion circuit to reduce the amount of power supplied to the source unit 20 or the cartridge heater, or to stop supply of power to the source unit 20 or the cartridge heater based on the temperature of the insertion space, the aerosol-generating article, and/or the cartridge heater exceeding a predetermined limit temperature.

In accordance with an embodiment, the processor 170 may control the supply of power to the source unit 20 or the cartridge heater based on the result sensed by the sensor unit.

In accordance with an embodiment, the processor 170 may control the supply of power to the source unit 20 or the cartridge heater based on the insertion and/or removal of the aerosol-generating article into and/or from the insertion space. For example, the processor 170 may perform control such that power is supplied to the source unit 20 or the cartridge heater upon determining that the aerosol-generating article has been inserted into the insertion space using the insertion detection sensor. The processor 170 may interrupt the supply of power to the source unit 20 or the cartridge heater upon determining that the aerosol-generating article has been removed from the insertion space using the insertion detection sensor. If the temperature of the insertion space or the aerosol-generating article is equal to or greater than the limit temperature or if the change slope of the temperature of the insertion space or the aerosol-generating article is equal to or greater than a set slope, the processor 170 may determine that the aerosol-generating article has been removed from the insertion space.

In accordance with an embodiment, the processor 170 may control the supply time and/or supply amount of power to the source unit 20 or the cartridge heater based on the state of the aerosol-generating article. For example, the processor 170 may increase the supply time of power (e.g., warm-up time) to the source unit 20 or the cartridge heater upon determining that the aerosol-generating article is overmoisturized using the overmoisture detection sensor.

In accordance with an embodiment, the processor 170 may control the supply of power to the source unit 20 or the cartridge heater based on whether the aerosol-generating article is to be reused. For example, the processor 170 may interrupt the supply of power to the source unit 20 or the cartridge heater upon determining that the aerosol-generating article has been used.

In accordance with an embodiment, the processor 170 may control the supply of power to the source unit 20 or the cartridge heater based on coupling and/or removal of the cartridge. For example, the processor 170 may stop the supply of power to the source unit 20 or the cartridge heater, or may perform control such that no power is supplied to the source unit 20 or the cartridge heater, upon determining that the cartridge has been removed using the cartridge detection sensor.

In accordance with an embodiment, the processor 170 may control the supply of power to the source unit 20 or the cartridge heater based on whether the aerosol-generating substance in the cartridge is exhausted. For example, the processor 170 may determine that the aerosol-generating substance in the cartridge has been exhausted upon determining that the temperature of the cartridge heater exceeds the limit temperature while the cartridge heater is warming up (i.e., during a warm-up period). Upon determining that the aerosol-generating substance in the cartridge has been exhausted, the processor 170 may interrupt the supply of power to the source 20 or the cartridge heater.

In accordance with an embodiment, the processor 170 may control the supply of power to the source unit 20 or the cartridge heater based on the availability of the cartridge. For example, the processor 170 may determine that the cartridge is unavailable upon determining that the current number of puffs is equal to or greater than the maximum number of puffs set for the cartridge based on data stored in the memory. Alternatively, the processor 170 may determine that the cartridge is unavailable if the total time the cartridge heater has been heated is equal to or greater than a preset maximum time or the total amount of power supplied to the cartridge heater is equal to or greater than a preset maximum amount of power. In this case, the processor 170 may stop the supply of power to the source unit 20 or the cartridge heater, or may perform control such that no power is supplied to the source unit 20 or the cartridge heater.

In accordance with an embodiment, the processor 170 may control the supply of power to the source unit 20 or the cartridge heater based on the user's puff. For example, the processor 170 may determine whether a puff has occurred and/or the intensity of the puff using the puff sensor. The processor 170 may interrupt the supply of power to the source unit 20 or the cartridge heater when the number of puffs reaches a preset maximum number of puffs and/or when no puffs are sensed for a preset period of time. The processor 170 may control the supply of power to the source unit 20 or the cartridge heater when a puff is detected.

In accordance with an embodiment, the processor 170 may control the supply of power to the source unit 20 or the cartridge heater based on the authenticity and/or type of the aerosol-generating article (or, the cartridge). For example, the processor 170 may detect the authenticity and/or type of the aerosol-generating article using the cigarette identification sensor. In an example, the processor 170 may interrupt the supply of power to the source unit 20 or the cartridge heater if the aerosol-generating article (or the cartridge) is detected to be counterfeit. The processor 170 may control (e.g., initiate) the supply of power to the source unit 20 or the cartridge heater if the aerosol-generating article (or the cartridge) is detected to be genuine. In another example, the processor 170 may control the supply of power to the source unit 20 or the cartridge heater differently depending on the type of the aerosol-generating article (or the cartridge). More specifically, the processor 170 may control the amplification rate of the source unit 20 or the temperature and/or power of the cartridge heater based on a first temperature profile (or a first power profile) if the aerosol-generating article (or the cartridge) is detected to be a first aerosol-generating article (or a first cartridge), and may control the amplification rate of the source unit 20 or the temperature and/or power of the cartridge heater based on a second temperature profile (or a second power profile) if the aerosol-generating article (or the cartridge) is detected to be a second aerosol-generating article (or a second cartridge).

In accordance with an embodiment, the processor 170 may control the output unit based on the result sensed by the sensor unit. For example, the processor 170 may control the output unit to visually, tactually, and/or audibly provide information that the aerosol-generating device 1 is about to shut down when the number of puffs counted using the puff sensor reaches a preset number. For example, the processor 170 may control the output unit to visually, tactually, and/or audibly provide information about the temperature of the insertion space, the aerosol-generating article, or the cartridge heater.

In accordance with an embodiment, the processor 170 may store and update the history of a predetermined event in the memory based on the occurrence of the event. For example, the event may include an operation performed by the aerosol-generating device 1, such as detecting insertion of the aerosol-generating article, initiating heating of the aerosol-generating article, detecting puffing, terminating puffing, detecting overheating, detecting application of overvoltage to the cartridge heater, terminating heating of the aerosol-generating article, turning on/off the aerosol-generating device 1, initiating charging of the power source 130, detecting overcharging of the power source 130, or terminating charging of the power source 130. For example, the history of the event may include the date when the event occurred or log data corresponding to the event. For example, if the predetermined event is detection of insertion of an aerosol-generating article, the log data corresponding to the event may include data about a sensing value of the insertion detection sensor. For example, if the predetermined event is detection of overheating of the cartridge heater, the log data corresponding to the event may include data about the temperature of the cartridge heater, the voltage applied to the cartridge heater, or the current flowing in the cartridge heater.

In accordance with an embodiment, the processor 170 may control the communication unit to form a communication link with an external device, such as a mobile terminal of the user.

In accordance with an embodiment, the processor 170 may lift a restriction on the use of at least one function (e.g., a heating function) of the aerosol-generating device 1 upon receiving data regarding authentication from the external device via the communication link. For example, the data regarding the authentication may include user's birthday, a unique number indicative of the user, or whether the user has completed authentication.

In accordance with an embodiment, the processor 170 may transmit data about the state of the aerosol-generating device 1 (e.g., the remaining capacity of the power source 130 or the operation mode) to the external device via the communication link. The transmitted data may be output through a display of the external device.

In accordance with an embodiment, upon receiving a request to search for the location of the aerosol-generating device 1 from the external device via the communication link, the processor 170 may control the output unit to perform an operation corresponding to the location search. For example, the processor 170 may control the haptic portion to generate vibration, or may control the display to output an object corresponding to the location search and the search termination.

In accordance with an embodiment, the processor 170 may perform firmware update upon receiving firmware data from the external device via the communication link.

In accordance with an embodiment, the processor 170 may transmit data about a sensing value of at least one sensor unit to an external server (not shown) via the communication link, and may receive and store a learning model generated by learning the sensing value through machine learning, such as deep learning, from the server. The processor 170 may perform an operation such as determining a user's inhalation pattern or generating a temperature profile using the learning model received from the server.

Although not shown in FIG. 1, the aerosol-generating device 1 may further include a protection circuit module. The protection circuit module may include at least one switching element and may block a path to the power source 130 in response to overcharging and/or overdischarging of the power source 130.

The aerosol-generating article mentioned in the present disclosure may include at least one aerosol-generating rod (e.g., a medium portion) and at least one filter rod. The radiating unit 30 may be disposed so as to correspond to the at least one aerosol-generating rod, and may be designed differently depending on the arrangement order and/or position of the aerosol-generating rod and the filter rod. The aerosol-generating rod may include at least one of nicotine, an aerosol-generating substance, and an additive. For example, the aerosol-generating substance may include glycerin (e.g., vegetable glycerin (VG)) and/or propylene glycol (PG), and may include various other substances. For example, the additive may include a flavoring agent and/or an organic acid, and may include various other substances. For example, the aerosol-generating rod may include an aerosol-generating substrate (e.g., a sheet) impregnated with a non-tobacco substance (e.g., an aerosol-generating substance and/or nicotine) in a liquid state, and/or a tobacco substance (e.g., tobacco leaf or reconstituted tobacco) in a solid state. The tobacco substance may be included in the aerosol-generating rod in various forms, such as cut tobacco, granule, or powder. In accordance with an embodiment, the additive of the aerosol-generating rod may include a basic substance. Based on the basic substance, the nicotine of the tobacco substance included in the aerosol-generating rod may have a basic pH (e.g., pH 7.0 or higher). In this case, freebase nicotine may be emitted from the aerosol-generating rod even at low temperatures. In accordance with an embodiment, the aerosol-generating rod may include two or more aerosol-generating rods, wherein each of the two or more aerosol-generating rods may include a tobacco substance and/or a non-tobacco substance. Meanwhile, although not shown, the at least one aerosol-generating rod and the at least one filter rod may individually and/or collectively be wrapped by at least one wrapper. In the present disclosure, the aerosol-generating article may be referred to as a stick.

The cartridge mentioned in the present disclosure may contain an aerosol-generating substance in one of a liquid state, a solid state, a gaseous state, or a gel state. The aerosol-generating substance may include a liquid composition. For example, the liquid composition may be a liquid including a tobacco-containing substance, including a volatile tobacco flavor component, or may be a liquid including a non-tobacco substance. Meanwhile, the cartridge may include a reservoir including the aerosol-generating substance and/or a liquid delivery means impregnated with (containing) the aerosol-generating substance. For example, the liquid delivery means may include a wick, such as a cotton fiber, ceramic fiber, glass fiber, or porous ceramic. The cartridge heater may be included in a cartridge in a coil-shaped structure surrounding (or winding) the liquid delivery means or in contact with one side of the liquid delivery means. Alternatively, the cartridge heater may be included in the aerosol-generating device 1, which is separable from the cartridge.

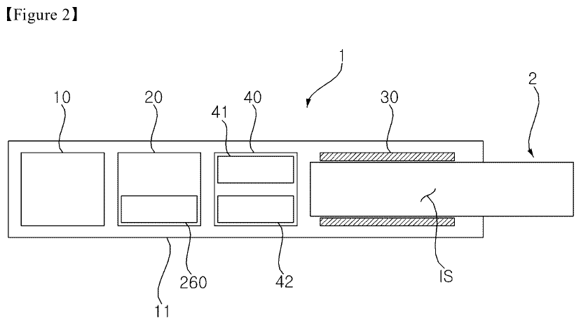

FIG. 2 is a view showing an aerosol-generating device 1 according to an embodiment of the present disclosure.

According to an embodiment, the aerosol-generating device 1 may include a body 11 (e.g., housing), a controller 10, a source unit 20, a radiating unit 30, and a printed circuit board 40. However, it will be understood by those skilled in the art that the components included in the aerosol-generating device 1 are not limited to those shown in FIG. 2, and some of the components may be omitted or new components may be added. The aerosol-generating device 1 shown in FIG. 2 may be referred to as an external heating-type aerosol-generating device, which heats the outer side of an aerosol-generating article 2. In the following drawings, redundant descriptions of the same components as those shown in FIG. 2 will be omitted.

According to an embodiment, the body 11 may have an upwardly open space defined therein to allow the aerosol-generating article 2 to be inserted thereinto. In the present disclosure, the upwardly open space may be referred to as an insertion space IS. The insertion space IS may be recessed to a predetermined depth in the body 11 so that at least a portion of the aerosol-generating article 2 is inserted thereinto. The depth of the insertion space IS may be equal to or greater than the length of the region of the aerosol-generating article 2 that contains an aerosol-generating substance and/or a medium. A lower end of the aerosol-generating article 2 may be inserted into the body 11, and an upper end of the aerosol-generating article 2 may protrude outside the body 11. A user may hold the outwardly exposed upper end of the aerosol-generating article 2 in the mouth to inhale aerosol.

According to an embodiment, the radiating unit 30 may heat the aerosol-generating article 2. Referring to FIG. 2, the radiating unit 30 may have an external heating-type structure.

According to an embodiment, the radiating unit 30 may be disposed around the insertion space IS, into which the aerosol-generating article 2 is inserted, and may be elongated upward. For example, the radiating unit 30 may be disposed to surround at least a portion of the insertion space IS. In one example, the radiating unit 30 may include a tubular form (e.g., cylindrical shape) including a hollow portion defined therein. The radiating unit 30 may include a form that includes a hollow portion defined therein and surrounds the hollow portion. The radiating unit 30 may be disposed to surround at least a portion of the insertion space IS. The radiating unit 30 may heat the outer side of the aerosol-generating article 2 inserted into the hollow portion.

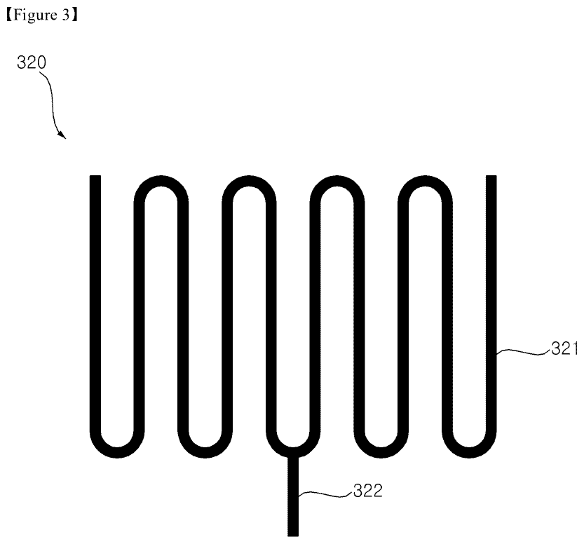

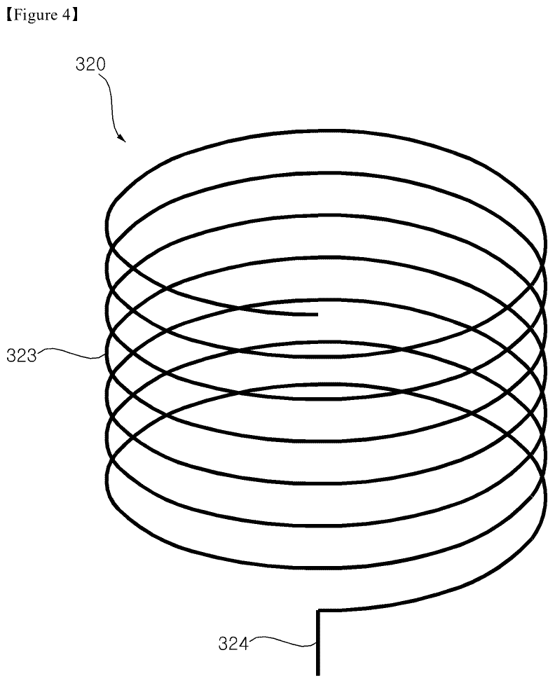

According to an embodiment, the radiating unit 30 may include a dielectric heater. The aerosol-generating device 1 may include a tubular antenna 320 (see FIGS. 3 and 4) surrounding the insertion space IS. Meanwhile, a heat insulator may be disposed outside the radiating unit 30. This may reduce the amount of heat emitted in a radially outward direction from the radiating unit 30 and radiated to the outside of the body 11.

According to an embodiment, the radiating unit 30 may be a multi-heater. A first antenna and a second antenna may be disposed in parallel with each other in a longitudinal direction so as to respectively surround at least a portion of the insertion space IS. The first antenna and the second antenna may operate as dielectric heaters and may sequentially or simultaneously radiate electromagnetic waves.

Unlike the configuration shown in FIG. 2, the antenna of the radiating unit 30 may be wound around a rod-shaped or needle-shaped structure and may be inserted into the aerosol-generating article 2 through a lower portion of the aerosol-generating article 2. In this case, electromagnetic waves radiated from the antenna may propagate outside from the inside of the aerosol-generating article 2 to heat the aerosol-generating article 2.

The source unit 20 may provide a radio-frequency (RF) signal to the antenna 320 of the radiating unit 30. The source unit 20 may include at least some of the components described above with reference to FIG. 1 (e.g., the RF signal generating circuit 210, the drive amplifier 220, the power amplifier 230, the directional coupler 240, and the temperature sensing circuit 250).

The source unit 20 may include a coupler 260. The coupler 260 may output a monitoring signal based on the RF signal output to the antenna 320. The coupler 260 may extract a portion of the output RF signal and may transmit the extracted portion of the RF signal to the processor 170 of the controller 10 (see FIG. 1). The portion of the RF signal extracted by the coupler 260 may be defined as a monitoring signal. The coupler 260 may be a passive component having a waveguide structure capable of separating a portion of the output RF signal. The coupler 260 may output a portion of the output RF signal as the monitoring signal and may output the remaining portion of the RF signal to the antenna 320. For example, the coupler 260 may output, as the monitoring signal, a signal having a magnitude less than about one-tenth of the magnitude of the output RF signal. The coupler 260 may be configured as a component included in the directional coupler 240 (see FIG. 1) or may be separately configured from the directional coupler 240.

The printed circuit board (PCB) 40 may electrically connect the source unit 20 to the antenna 320. The printed circuit board 40 may transmit the RF signal provided from the source unit 20 or the RF signal output from the coupler 260 to the antenna 320.

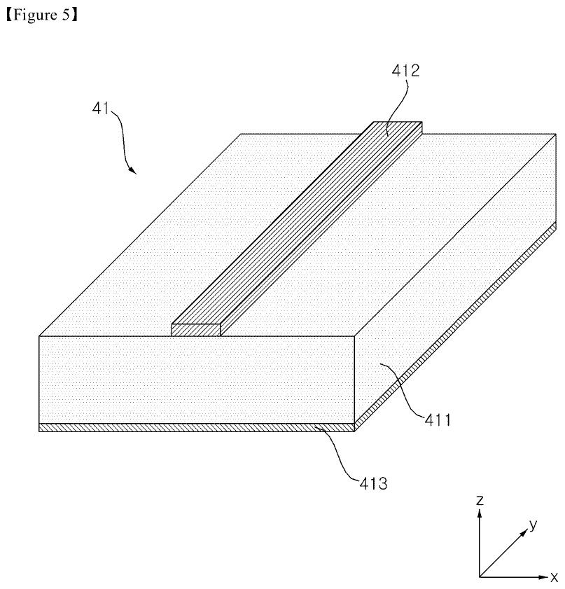

The printed circuit board 40 may include a first part 41. The printed circuit board 40 may further include a second part 42. The first part 41 may be electrically connected to the source unit 20 and the antenna 320. The second part 42 may be electrically connected to the coupler 260 and the processor 170. The first part 41 and the second part 42 will be described later in detail with reference to FIGS. 5 to 12.

According to an embodiment, the aerosol-generating device 1 may be provided with an airflow channel through which air flows. For example, the body 11 may include a structure (e.g., hole) through which external air flows into the body 11. Air introduced into the body 11 may flow into the aerosol-generating article 2 through the lower end (i.e., upstream side) of the aerosol-generating article 2. Aerosol generated based on heating of the aerosol-generating article 2 may be inhaled into the mouth of a user together with the introduced air through the upper end (i.e., downstream side) of the aerosol-generating article 2.

FIGS. 3 and 4 are views showing an antenna 320 according to an embodiment of the present disclosure.

Referring to FIG. 3, the antenna 320 may be of a thin-film type, i.e., may have a thin and wide shape, and may be rolled to form a hollow structure. The antenna 320 may be formed by etching a metal thin film with a laser. The antenna 320 may radiate a radio-frequency (RF) signal generated by the source unit 20 to the insertion space IS in the form of microwaves. In this case, the microwaves may refer to electromagnetic waves having a frequency of 300 MHz to 300 GHz.

The antenna 320 may include a radiating track 321 and a connecting portion 322. The antenna 320 may be an antenna having an overall meandering shape extending in both directions.

The radiating track 321 may include at least one track. For example, the radiating track 321 may include two tracks extending in different directions. Each of the tracks may include at least one bent portion and may have a meandering shape. The tracks may be symmetrical to each other. Each of the tracks may have an end connected to an end of the other track and a free opposite end.

The connecting portion 322 may protrude outward from one side of the radiating track 321. The connecting portion 322 may be integrally formed with the radiating track 321. The connecting portion 322 may be connected to the source unit 20 to receive an RF signal from the source unit 20.

However, the shape of the antenna 320 is not limited to the above-described shape. The antenna 320 may include a structure such as a loop-type antenna, a planar inverted F antenna (PIFA), a monopole antenna, or a dipole antenna.

The antenna 320 may include an insulator surrounding at least a portion of each of inner and outer sides of the radiating track 321 and the connecting portion 322. The insulator may be a flexible sheet formed of a heat-resistant material. The insulator may include polyimide or polyetheretherketone (PEEK). However, the disclosure is not limited thereto. The insulator may include other materials having elasticity, heat resistance, and electrical insulation.

Referring to FIG. 4, the antenna 320 may have a spiral structure. The antenna 320 may include a spiral track 323 and a connecting portion 324.

The spiral track 323 may have a shape in which an elongated line is wound to form a plurality of turns in a spiral shape. One end of the spiral track 323 may be connected to the connecting portion 324. The connecting portion 324 may protrude outward from one side of the spiral track 323. The connecting portion 324 may be integrally formed with the spiral track 323. The connecting portion 324 may be connected to the source unit 20 to receive an RF signal from the source unit 20.

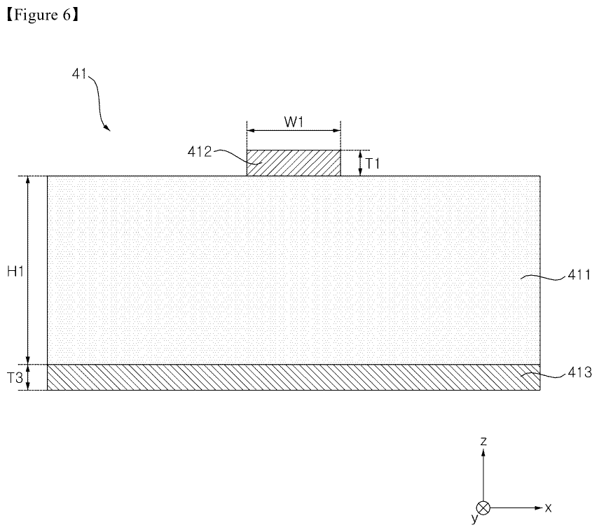

FIG. 5 is a perspective view of a first part 41 according to an embodiment of the present disclosure, and FIG. 6 is a cross-sectional view of the first part 41. Referring to FIGS. 5 and 6, the printed circuit board 40 may include the first part 41. The first part 41 may have a structure in which a plurality of layers is stacked. The first part 41 may include a first insulating layer 411, a transmission line 412, and a first ground layer 413.

The first insulating layer 411, which serves as a base substrate of the first part 41, may be elongated in one direction (e.g., the x direction or the y direction). The first insulating layer 411 may include an insulator. The insulator may include glass fiber, epoxy resin, or the like. For example, the first insulating layer 411 may include an FR4 material.

The transmission line 412 may be disposed on one surface or an upper surface of the first insulating layer 411. The transmission line 412 may have two opposite ends electrically connected to the source unit 20 and the antenna 320, respectively. The transmission line 412 may include a conductive material. The transmission line 412 may be formed by laminating a metal foil on one surface of the first insulating layer 411 and etching the laminated metal foil into a line shape.

The first ground layer 413 may be disposed on the opposite surface or a lower surface of the first insulating layer 411. The first ground layer 413 may include a conductive material. For example, the transmission line 412 and the first ground layer 413 may be formed of at least one of copper, lead, tin, gold, silver, aluminum, iron, zinc, or an alloy thereof.

In the structure of the first part 41 including the first insulating layer 411, the transmission line 412, and the first ground layer 413, a characteristic impedance ZO may be expressed using Equation 1 below. Equation 1 below is merely an example for calculating the characteristic impedance ZO, which is derived through numerical analysis. Therefore, various mathematical formulas other than Equation 1 below may also be used to calculate the characteristic impedance.

$${Z}_{0} = \frac{87}{\sqrt{1.41 + {ε}_{r}}} \times ln ( \frac{5.98 \times H}{T + 0.8 \times W} ) \qquad [ Equation 1 ]$$

In Equation 1 above, ZO represents the characteristic impedance, H represents the thickness of the insulating layer, er represents the dielectric constant of the insulating layer, T represents the thickness of the transmission line, and W represents the width of the transmission line.

The characteristic impedance ZO of the first part 41 may have a value within a predetermined range so as to correspond to or match an input impedance Za of the antenna 320. For example, the antenna 320 may have an input impedance Za of 25 to 75 ohms, and the characteristic impedance ZO may be equal to the input impedance Za of the antenna 320 or may have a value within a predetermined error range (e.g., 5% or less) based on the input impedance Za of the antenna 320.

The structures and properties of the first insulating layer 411, the transmission line 412, and the first ground layer 413 of the first part 41 may be determined such that the characteristic impedance ZO of the first part 41 has a value of 25 to 75 ohms.

The transmission line 412 may have a width W1 within a predetermined range. The width W1 of the transmission line 412 may be 1.5 to 2.5 mm. In some embodiments, the width W1 of the transmission line 412 may be about 2 mm. When the width W1 of the transmission line 412 is 2 mm, a current of up to 3.4 A may stably flow through the transmission line 412. Accordingly, sufficient power may be transmitted from the source unit 20 to the antenna 320 in order to heat the aerosol-generating article 2.

The insulator of the first insulating layer 411 may have a dielectric constant of 3.8 to 4.8. In some embodiments, the dielectric constant of the insulator of the first insulating layer 411 may be about 4.25.

The first insulating layer 411 may have a thickness H1 of 0.4 to 1.6 mm. In some embodiments, the thickness H1 of the first insulating layer 411 may be 0.4 to 1.0 mm. When the thickness H1 of the first insulating layer 411 is less than 0.4 mm, the characteristic impedance ZO of the first part 41 may be less than 25 ohms. When the thickness H1 of the first insulating layer 411 is greater than 1.6 mm, the thickness of the printed circuit board 40 may increase, thereby making it difficult to achieve miniaturization of the device and to manufacture the printed circuit board 40 and increasing manufacturing cost.

In the structure shown in FIGS. 5 and 6, main factors determining the magnitude of the characteristic impedance ZO of the first part 41 may include the dielectric constant of the insulator of the first insulating layer 411 and the thickness H1 of the first insulating layer 411. According to the embodiment of the present disclosure, the dielectric constant and the thickness H1 of the first insulating layer 411 of the first part 41 may be set to fall within predetermined ranges, so that the characteristic impedance ZO of the first part 41 may be accurately determined.

The first ground layer 413 may have a larger width than the transmission line 412. In the thickness direction of the first insulating layer 411 (e.g., the z direction), the first ground layer 413 may overlap all portions in which the transmission line 412 is formed. In other words, the first ground layer 413 may be insulated from the transmission line 412 by the first insulating layer 411 and may cover all regions in which the transmission line 412 is disposed.

The first ground layer 413 may have a thickness T3 substantially equal to the thickness T1 of the transmission line 412. The thickness T1 of the transmission line 412 may be 0.01 to 0.02 mm. In some embodiments, the thickness T1 of the transmission line 412 may be 0.013 mm. Accordingly, the same metal foil may be used to fabricate the transmission line 412 and the first ground layer 413, and the fabrication process may be simplified, thereby facilitating manufacture of the device and reducing manufacturing cost. However, the thickness T3 of the first ground layer 413 is not limited thereto and may be varied depending on design specifications.

The transmission line 412 may have a length of about 20 mm or less. However, because the length of the transmission line 412 hardly affects the value of the characteristic impedance ZO of the first part 41, the length of the transmission line 412 may be set to be greater than 20 mm depending on design specifications.

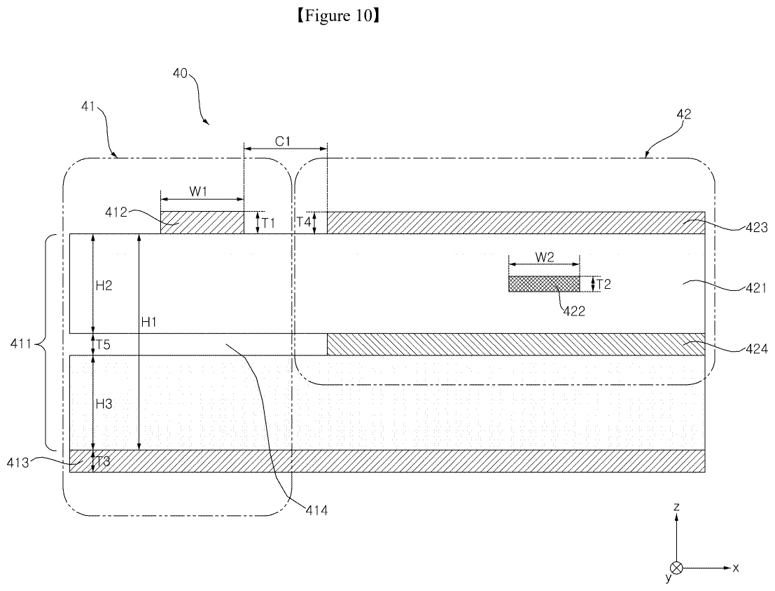

Although the first insulating layer 411 is illustrated in FIGS. 5 and 6 as being configured as a single insulating layer, the first insulating layer 411 may include a plurality of insulating layers. For example, the first insulating layer 411 may be formed by stacking a plurality of insulating layers having the same thickness or different thicknesses. In this case, an air layer (e.g., an air layer 414 (see FIG. 10)) may be formed between two insulating layers stacked to face each other. The air layer may have a smaller thickness than each of the insulating layers facing each other. For example, the thickness of the air layer may be equal to or less than one-fifth of the thickness of each of the insulating layers facing each other.

When the printed circuit board 40 includes another electric circuit in addition to the first part 41, insulating layers having a different thickness from the first insulating layer 411 of the first part 41 may be provided in the printed circuit board 40. When the first insulating layer 411 includes a plurality of insulating layers, the substrate configuration of the electric circuit other than the first part 41 provided in the printed circuit board 40 may be facilitated, and the manufacturing cost of the printed circuit board 40 may be reduced.

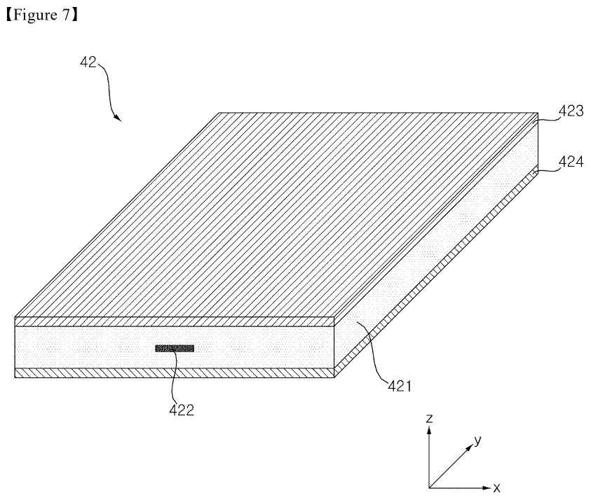

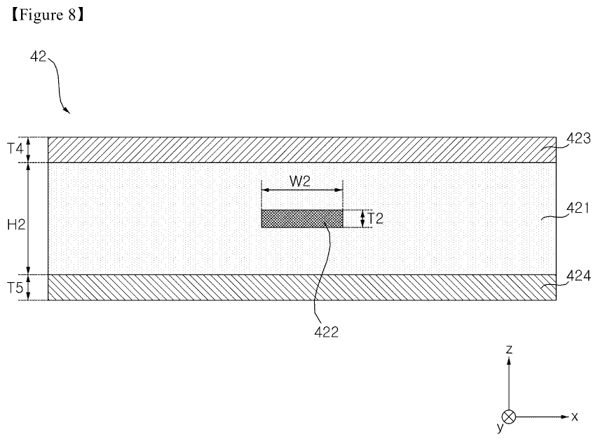

FIG. 7 is a perspective view of a second part according to an embodiment of the present disclosure, and FIG. 8 is a cross-sectional view of the second part.

Referring to FIGS. 7 and 8, the printed circuit board 40 may include a second part 42. The second part 42 may be electrically connected to the coupler 260 and the processor 170. A monitoring signal output from the coupler 260 may be transmitted to the processor 170 through the second part 42.

The second part 42 may have a structure in which a plurality of layers is stacked. The second part 42 may include a second insulating layer 421, a feedback line 422, a second ground layer 423, and a third ground layer 424.

The second insulating layer 421, which serves as a base substrate of the second part 42, may be elongated in one direction (e.g., the x direction or the y direction). The second insulating layer 421 may include an insulator. The second insulating layer 421 may be fabricated using the same insulator as the first insulating layer 411. For example, the second insulating layer 421 may include an FR4 material.

The feedback line 422 may be disposed inside the second insulating layer 421. The feedback line 422 may be disposed at the center of the second insulating layer 421 or at a position adjacent to the center in the thickness direction of the second insulating layer 421 (e.g., the z direction). The feedback line 422 may have two opposite ends electrically connected to an output terminal of the coupler 260 and the processor 170, respectively. The feedback line 422 may include a conductive material.

The second ground layer 423 may be disposed on one surface or an upper surface of the second insulating layer 421. The third ground layer 424 may be disposed on the opposite surface or a lower surface of the second insulating layer 421. The second ground layer 423 and the third ground layer 424 may be electrically connected to each other. For example, the second ground layer 423 and the third ground layer 424 may be electrically connected to each other via a via formed in the thickness direction between the second ground layer 423 and the third ground layer 424 or may be electrically connected to each other via an external circuit (e.g., the source unit 20) connected to the printed circuit board 40. The second ground layer 423 and the third ground layer 424 may include a conductive material. For example, the feedback line 422, the second ground layer 423, and the third ground layer 424 may be formed of at least one of copper, lead, tin, gold, silver, aluminum, iron, zinc, or an alloy thereof.

The feedback line 422 may have a width W2 within a predetermined range. The width W2 of the feedback line 422 may be 0.03 to 0.24 mm. In some embodiments, the width W2 of the feedback line 422 may be about 0.135 mm. The feedback line 422, which serves as a line that transmits a monitoring signal output from the coupler 260, may have a structure that carries a smaller current compared to the transmission line 412. For example, a maximum current flowing through the feedback line 422 may be equal to or less than about one-tenth of a maximum current flowing through the transmission line 412.

The second insulating layer 421 may be formed of the same material as the first insulating layer 411. The insulator of the second insulating layer 421 may have a dielectric constant of 3.8 to 4.8.

The second insulating layer 421 may have a smaller thickness H2 than the first insulating layer 411. For example, the thickness H2 of the second insulating layer 421 may be 0.18 to 0.2 mm.

The second ground layer 423 and the third ground layer 424 may have a larger width than the feedback line 422. In the thickness direction of the second insulating layer 421, each of the second ground layer 423 and the third ground layer 424 may overlap all portions in which the feedback line 422 is formed. In other words, each of the second ground layer 423 and the third ground layer 424 may be insulated from the feedback line 422 by the second insulating layer 421 and may cover all regions in which the feedback line 422 is disposed.

The second ground layer 423 may have a thickness T4 substantially equal to the thickness T2 of the feedback line 422, and the third ground layer 424 may have a thickness T5 substantially equal to the thickness T2 of the feedback line 422. The thickness T2 of the feedback line 422 may be 0.01 to 0.02 mm. In some embodiments, the thickness T2 of the feedback line 422 may be 0.013 mm. Accordingly, the same metal foil may be used to fabricate the feedback line 422 and the ground layers 423 and 424, and the fabrication process may be simplified, thereby facilitating manufacture of the device and reducing manufacturing cost. However, the thickness T4 of the second ground layer 423 and the thickness T5 of the third ground layer 424 are not limited thereto and may be varied depending on design specifications.

Although the second insulating layer 421 is illustrated in FIGS. 7 and 8 as being configured as a single insulating layer, the second insulating layer 421 may include a plurality of insulating layers. For example, the second insulating layer 421 may be formed by stacking a plurality of insulating layers having the same thickness or different thicknesses.

Because the feedback line 422 is disposed inside the second insulating layer 421, when the second insulating layer 421 includes a plurality of layers, the feedback line 422 may be formed by performing an etching process on a specific insulating layer among the plurality of layers, and the other insulating layers may be stacked to cover the feedback line 422. Accordingly, fabrication of the second part 42 may be facilitated, and the manufacturing cost of the printed circuit board 40 may be reduced.

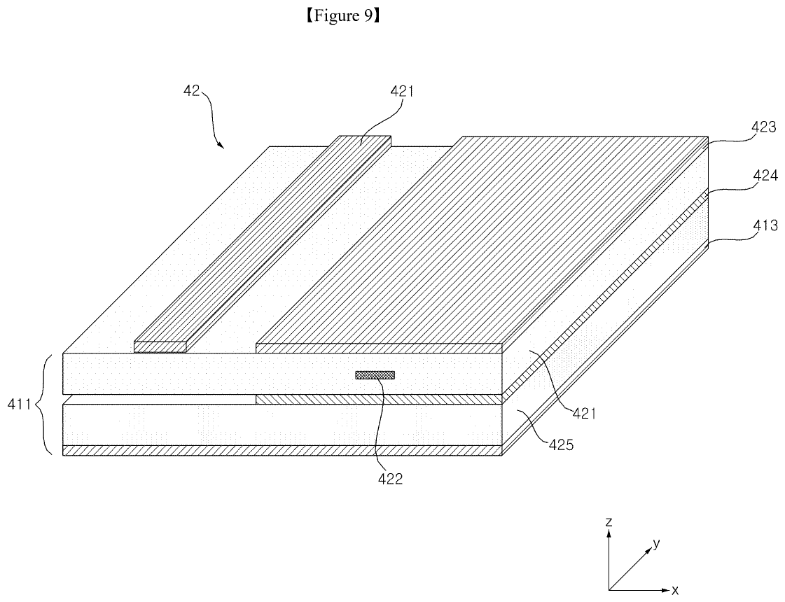

FIG. 9 is a perspective view of a printed circuit board 40 including the first part 41 and the second part 42 according to an embodiment of the present disclosure, and FIG. 10 is a cross-sectional view of the printed circuit board 40.

Referring to FIGS. 9 and 10, the printed circuit board 40 may include the first part 41 and the second part 42. The first part 41 and the second part 42 may be provided in one printed circuit board 40.

The first part 41 and the second part 42 may be disposed adjacent to each other or in parallel with each other in the extending direction of the printed circuit board 40 or the extending direction of each part (e.g., the x direction). For example, the first part 41 may be formed on one side of the printed circuit board 40, and the second part 42 may be formed on the opposite side of the printed circuit board 40 so as to be spaced apart from the first part 41.

The first part 41 and the second part 42 may share at least a portion of the insulating layers. For example, the second insulating layer 421 of the second part 42 may be one of the plurality of insulating layers forming the first insulating layer 411 of the first part 41. The first insulating layer 411 may include a plurality of layers 421 and 425 stacked one above the other, and the second insulating layer 421 may form one of the plurality of layers 421 and 425 of the first insulating layer 411.

The transmission line 412 of the first part 41 and the second ground layer 423 of the second part 42 may be disposed on the same surface of the first insulating layer 411 or on the same surface of the second insulating layer 421. In other words, the transmission line 412 and the second ground layer 423 may form one layer in the printed circuit board 40. The transmission line 412 and the second ground layer 423 may be disposed apart from each other by a predetermined distance or more. For example, a spacing distance C1 between the transmission line 412 and the second ground layer 423 may be equal to or greater than 0.5 times the width W1 of the transmission line 412.

The first ground layer 413, the second ground layer 423, and the third ground layer 424 may be electrically connected to each other. For example, the first ground layer 413, the second ground layer 423, and the third ground layer 424 may be electrically connected to each other via vias formed in the thickness direction so as to be connected to the respective layers or may be electrically connected to each other via an external circuit (e.g., the source unit 20) connected to the printed circuit board 40.

Accordingly, interference between the transmission line 412 and the second ground layer 423 may be minimized, and interference between the transmission line 412 and the feedback line 422 may be prevented by the second ground layer 423.

An air layer 414 may be formed between the plurality of layers constituting the first insulating layer 411. The air layer 414 may form one layer with the third ground layer 424. In other words, the air layer 414 may be a layer formed by removing a portion of the third ground layer 424 during an etching process.

The thickness H1 of the first insulating layer 411 may be equal to a sum of the thickness of the second insulating layer 421, the thickness of the third insulating layer 425, and the thickness of the air layer 414. The thickness H2 of the second insulating layer 421 may be 0.18 to 0.2 mm, and the thickness H3 of the third insulating layer 425 may be 0.2 to 1.4 mm. The thickness T5 of the air layer 414 or the third ground layer 424 may be equal to or less than one-fifth of the thickness H2 of the second insulating layer 421. For example, the thickness T5 of the air layer 414 or the third ground layer 424 may be 0.01 to 0.02 mm.

Although each of the second insulating layer 421 and the third insulating layer 425 is illustrated in FIGS. 9 and 10 as being configured as a single insulating layer, at least one of the second insulating layer 421 or the third insulating layer 425 may include a plurality of insulating layers.

Accordingly, the first part 41 and the second part 42 may be provided in one printed circuit board 40, so that the circuit structure for antenna monitoring may be simplified, and miniaturization of the device may be achieved.

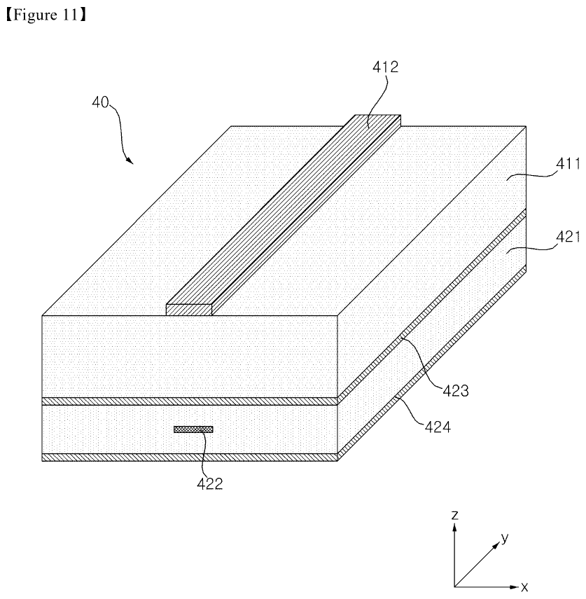

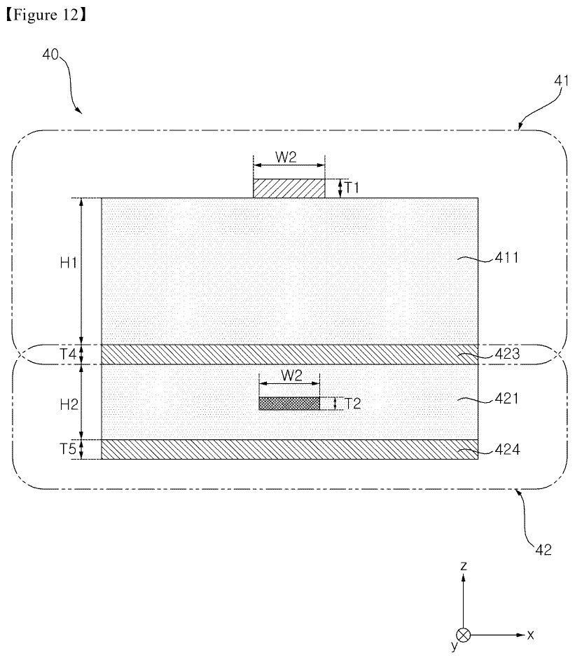

FIG. 11 is a perspective view of a printed circuit board 40 including the first part 41 and the second part 42 according to an embodiment of the present disclosure, and FIG. 12 is a cross-sectional view of the printed circuit board 40. The components of the first and second parts 41 and 42 shown in FIGS. 11 and 12 have the same thicknesses and widths as the components of the first and second parts 41 and 42 shown in FIGS. 5 to 8, and thus detailed descriptions thereof will be omitted.

Referring to FIGS. 11 and 12, the printed circuit board 40 may include the first part 41 and the second part 42. The first part 41 and the second part 42 may be provided in one printed circuit board 40.

The first part 41 and the second part 42 may be stacked one above the other. For example, the second part 42 may be stacked under the first part 41.

The second ground layer 423 of the second part 42 may be disposed between the first insulating layer 411 of the first part 41 and the second insulating layer 421 of the second part 42. The second ground layer 423 may be disposed between the transmission line 412 of the first part 41 and the feedback line 422 of the second part 42. In the stacked direction or the thickness direction of the printed circuit board 40, the second ground layer 423 may partition the first part 41 and the second part 42 from each other. The second ground layer 423 may be understood as the same ground layer as the first ground layer 413 shown in FIGS. 5 and 6.

Accordingly, interference between the transmission line 412 and the feedback line 422 may be prevented by the second ground layer 423.

In addition, because the first part 41 and the second part 42 are provided in one printed circuit board 40, the circuit structure for antenna monitoring may be simplified, and miniaturization of the device may be achieved.

As described above, according to at least one of the embodiments of the present disclosure, because the part of the printed circuit board that connects the source unit to the antenna has a characteristic impedance corresponding to an input impedance of the antenna, power loss of a signal transmitted from the source unit to the antenna may be minimized, damage to the source unit caused by a reflected wave may be prevented, and the device may be miniaturized.

According to at least one of the embodiments of the present disclosure, because the transmission line and the insulating layer of the printed circuit board have thicknesses and widths within a predetermined range, the characteristic impedance of the part that connects the source unit to the antenna may be accurately matched to the input impedance of the antenna.

According to at least one of the embodiments of the present disclosure, because the printed circuit board includes a part that connects the coupler to the processor as well as the part that connects the source unit to the antenna, the circuit structure for antenna monitoring may be simplified.

Referring to FIGS. 1 to 12, an aerosol-generating device 1 in accordance with one aspect of the present disclosure may include an antenna 320 configured to radiate microwaves to an insertion space IS accommodating an aerosol-generating article 2, a source unit 20 configured to provide a radio-frequency (RF) signal to the antenna 320, and a printed circuit board 40 connected to the source unit 20 and the antenna 320. The printed circuit board 40 may include a first part 41 including a first insulating layer 411 and a transmission line 412 disposed on one surface of the first insulating layer 411 and electrically connected to the source unit 20 and the antenna 320, and a characteristic impedance ZO of the first part 41 may correspond to an input impedance Za of the antenna 320.

In addition, in accordance with another aspect of the present disclosure, the characteristic impedance ZO may be in a range of 25 to 75 ohms.

In addition, in accordance with another aspect of the present disclosure, the first part 41 may include a first ground layer 413 disposed on the opposite surface of the first insulating layer 411.

In addition, in accordance with another aspect of the present disclosure, the first insulating layer 411 may include a dielectric, and the dielectric may have a dielectric constant in a range of 3.8 to 4.8.

In addition, in accordance with another aspect of the present disclosure, a thickness H1 of the first insulating layer 411 may be in a range of 0.4 to 1.0 mm.

In addition, in accordance with another aspect of the present disclosure, a width W1 of the transmission line 412 may be in a range of 1.5 to 2.5 mm.

In addition, in accordance with another aspect of the present disclosure, the first insulating layer 411 may include a plurality of insulating layers, and the aerosol-generating device may include at least one air layer formed between the plurality of insulating layers.

In addition, in accordance with another aspect of the present disclosure, the aerosol-generating device may include a processor 170 configured to control the RF signal, a coupler 260 configured to output a monitoring signal based on the RF signal, and a second part 42 provided in the printed circuit board 40 and connected to the coupler 260 and the processor 170 to transmit the monitoring signal to the processor 170.

In addition, in accordance with another aspect of the present disclosure, the second part 42 may include a second insulating layer 421 and a feedback line 422 disposed inside the second insulating layer 421 and electrically connected to the coupler 260 and the processor 170.

In addition, in accordance with another aspect of the present disclosure, the second part 42 may include a second ground layer 423 disposed on one surface of the second insulating layer 421 and a third ground layer 424 disposed on the opposite surface of the second insulating layer 421.

In addition, in accordance with another aspect of the present disclosure, the first insulating layer 411 may include a plurality of insulating layers, and the second insulating layer 421 may be one of the plurality of insulating layers forming the first insulating layer 411.

In addition, in accordance with another aspect of the present disclosure, the second ground layer 423 may be disposed on one surface of the first insulating layer 411 so as to be spaced apart from the transmission line 412.

In addition, in accordance with another aspect of the present disclosure, a distance C1 between the second ground layer 423 and the transmission line 412 may be equal to or greater than 0.5 times the width W1 of the transmission line 412.

In addition, in accordance with another aspect of the present disclosure, the second insulating layer 421 may be stacked on the first insulating layer 411.

In addition, in accordance with another aspect of the present disclosure, the second ground layer 423 may be disposed between the first insulating layer 411 and the second insulating layer 421.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An aerosol-generating device comprising:
an antenna configured to radiate microwaves to an insertion space accommodating an aerosol-generating article;
a source unit configured to provide a radio-frequency (RF) signal to the antenna; and
a printed circuit board connected to the source unit and the antenna,
wherein the printed circuit board comprises a first part comprising a first insulating layer and a transmission line disposed on one surface of the first insulating layer and electrically connected to the source unit and the antenna, and
wherein a characteristic impedance of the first part corresponds to an input impedance of the antenna.

2. The aerosol-generating device according to claim 1, wherein the characteristic impedance is in a range of 25 to 75 ohms.

3. The aerosol-generating device according to claim 1, wherein the first part comprises a first ground layer disposed on an opposite surface of the first insulating layer.

4. The aerosol-generating device according to claim 1, wherein the first insulating layer comprises a dielectric, and
wherein the dielectric has a dielectric constant in a range of 3.8 to 4.8.

5. The aerosol-generating device according to claim 4, wherein a thickness of the first insulating layer is in a range of 0.4 to 1.0 mm.

6. The aerosol-generating device according to claim 1, wherein a width of the transmission line is in a range of 1.5 to 2.5 mm.

7. The aerosol-generating device according to claim 1, wherein the first insulating layer comprises a plurality of insulating layers, and
wherein the aerosol-generating device comprises at least one air layer formed between the plurality of insulating layers.

8. The aerosol-generating device according to claim 1, comprising:
a processor configured to control the RF signal;
a coupler configured to output a monitoring signal based on the RF signal; and
a second part provided in the printed circuit board and connected to the coupler and the processor to transmit the monitoring signal to the processor.

9. The aerosol-generating device according to claim 8, wherein the second part comprises:
a second insulating layer; and
a feedback line disposed inside the second insulating layer and electrically connected to the coupler and the processor.

10. The aerosol-generating device according to claim 9, wherein the second part comprises:
a second ground layer disposed on one surface of the second insulating layer; and
a third ground layer disposed on an opposite surface of the second insulating layer.

11. The aerosol-generating device according to claim 9, wherein the first insulating layer comprises a plurality of insulating layers, and
wherein the second insulating layer is one of the plurality of insulating layers forming the first insulating layer.

12. The aerosol-generating device according to claim 10, wherein the second ground layer is disposed on one surface of the first insulating layer so as to be spaced apart from the transmission line.

13. The aerosol-generating device according to claim 12, wherein a distance between the second ground layer and the transmission line is equal to or greater than 0.5 times a width of the transmission line.

14. The aerosol-generating device according to claim 10, wherein the second insulating layer is stacked on the first insulating layer.

15. The aerosol-generating device according to claim 14, wherein the second ground layer is disposed between the first insulating layer and the second insulating layer.
